(19) United States
(12) Patent Application Publication
(10) Pub. No.: US 2009/0313393 A1
(43) Pub. Date: Dec. 17, 2009

(54) METHOD OF INCREASING EFFICIENCY OF END POINT MEMORY IN USB DEVICES

(76) Inventor: Hyeong-Jun Park, Gangnam-gu (KR)

Correspondence Address: SHERR & VAUGHN, PLLC, 620 HERNDON PARKWAY, SUITE 320, HERNDON, VA, 20170, US

(21) Appl. No.: 12/484,297

(22) Filed: Jun. 15, 2009

(30) Foreign Application Priority Data
Jun. 17, 2008 (KR) 10-2008-0056759

(51) Int. Cl. G06F 3/00

(52) U.S. Cl. 710/9

(57) ABSTRACT

A method maximizes efficiency of an end point memory in a USB device which conducts data communication with an external host. The method includes: assigning the memory to an end point at the point of time when the memory starts to be actually used; and returning the memory, which was assigned to the end point, at the point of time when the actual use of the memory is ended. When the end point is a reception end point, the point of time when the actual use starts is a point of time when the USB device receives an OUT token from the host, and the point of time when the actual use is ended is a point of time when the USB device confirms that data received from the host have no errors.

The present application claims priority under 35 U.S.C. 119 to Korean Patent Application No. 10-2008-0056759 (filed on Jun. 17, 2008), which is hereby incorporated by reference in its entirety.

### BACKGROUND

USB (Universal Serial Bus) is a kind of interface defined in the industry to connect peripheral devices to a PC system bus. In general communications, a buffer memory of an appropriate size may be provided for transmission efficiency. A USB device has end point memories corresponding to buffers at transmission and reception sides for maximized throughput, transmission rate and the like during communication with a host.

USB uses a token-based bus architecture. USB communication includes control, interrupt, bulk and isochronous data transmission.

When a USB device transmits data to a host, an MCU (Micro Controller Unit) of the USB device stores data to be transmitted in a transmission end point memory. When an In token, which is a transmission request signal sent from the host, is detected, the MCU then transmits the stored data sequentially. In case of control, interrupt and bulk transmission, transmission is completed when the USB device receives an ACK signal from the host. In the case of isochronous transmission, transmission is completed when the USB device has transmitted the data to the host.

The USB device may receive data from the host through a reception end point memory. The host sends an OUT token, which is a reception request signal, and when an error check confirms no errors in the received data, reception is complete. If new transmission is requested in spite of a situation where meaningful data are stored in all end point memories for subsequent process, a NACK signal is generated.

For USB device communication, paths to allow data to be bi-directionally transmitted are used as a channel connecting an end point within the USB device and a host. The USB device receives data from the host at a reception end point through the paths and transmits data input to a transmission end point to the host through the paths. In case of interrupt, bulk and isochronous transmission, the transmission end point and the reception end point are generally implemented by separate hardware.

A USB device may have up to 16 end points. At initialization of data communication between the USB device and the host, after the number and size of end points are reported to the host, if data larger than the reported end point size are to be transmitted, the data are cut to the end point size and are transmitted in the form of several packets.

Since the number of end points within the USB device is limited to 16, individual construction of end point memories in a plurality of end points in the design of a general-purpose controller requires a great amount of memory.

In addition, the transmittable packet size depends on the size of assigned end point memory. Accordingly, if the size of the packet is small, transmissions are divided several times, which results in reduction of transmission efficiency.

Moreover, in case where a host issues an IN token as a transmission request or issues an OUT token as a reception request, if there is no available end point memory at that point, a device directs a NACK signal to the host, which results in a reduction of transmission efficiency due to transmission delays.

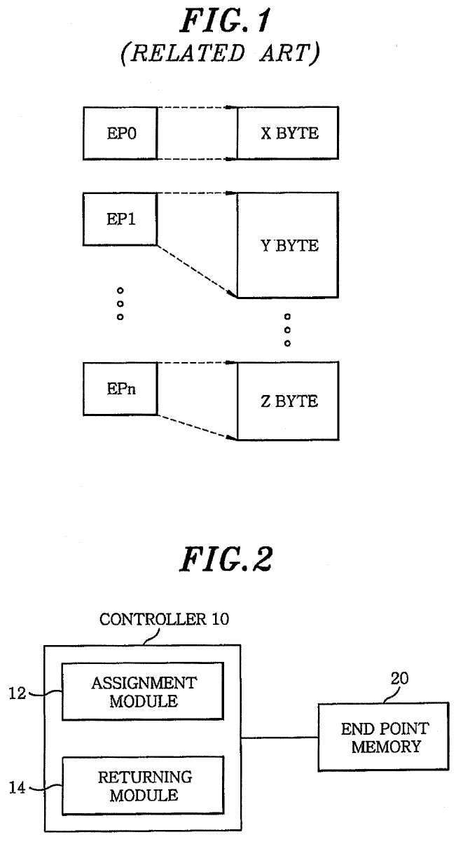

Example FIG. 1 shows use of end point memories within a USB device in the related art. In actuality, although a writable region with no data assigned thereto exists in an end point memory, that region may not be used. If all end point memories assigned to a current end point EP0 are in use, although end point memories assigned to other end points are not in used, the end point EPO can not use these end point memories of other end points. For all that there is a margin for end point memories from a general standpoint of device, a situation of end point memory insufficiency for individual end points may happen. In particular, it is problematic that an end point memory remains assigned although it is not actually in use.

### SUMMARY

Embodiments relate to a method of increasing efficiency of an end point memory in a USB device, and more particularly, to a method of increasing efficiency of an end point memory in a USB device, which includes assigning an end point memory to an end point at the point of time when a request for the end point memory is generated and returning the assigned end point memory at the point of time when the request is extinguished.

Embodiments relate to a method for increasing efficiency of an end point memory in a USB device which conducts data communication with an external host. The method includes assigning the memory to an end point at the point of time when the memory starts to be actually used and returning the memory, which was assigned to the end point, at the point of time when the actual use of the memory is ended.

When the end point is a reception end point, the point of time when the actual use starts is a point of time when the USB device receives an OUT token from the host, and the point of time when the actual use is ended is a point of time when the USB device confirms that data received from the host have no error.

Further, the end point may be a transmission end point, and the point of time when the actual use is ended may be a point of time when the USB device receives an ACK signal from the host if transmission of the data communication is one of control, interrupt and bulk transmission, or a point of time when the USB device transmits data to the host if transmission of the data communication is isochronous transmission.

The memory may be divided into segments having an equal size and an address map stores addresses or pointers of index values. Further, the method may further include dividing the memory into segments assigned to the end point and segments not assigned to the end point.

The address map may use a form of a connection list material structure.

In accordance with embodiments, chip size can be reduced by using end point memories efficiently to reduce a required memory size, which results in increase of the number of chips per wafer and hence reduction of production costs. In addition, since occurrence of NACK can be reduced with increase of end point memory efficiency, it is possible to prevent loss of CPU resources required for NACK processing and lowering of communication efficiency. Since end point memories are assigned only when actually necessary and are returned when unnecessary, there is no need of various tests to determine a size of an end point memory to be assigned to each end point, which results in increase in speed of research and development.

### DRAWINGS

Example FIG. 1 shows use of end point memories within a USB device in the related art.

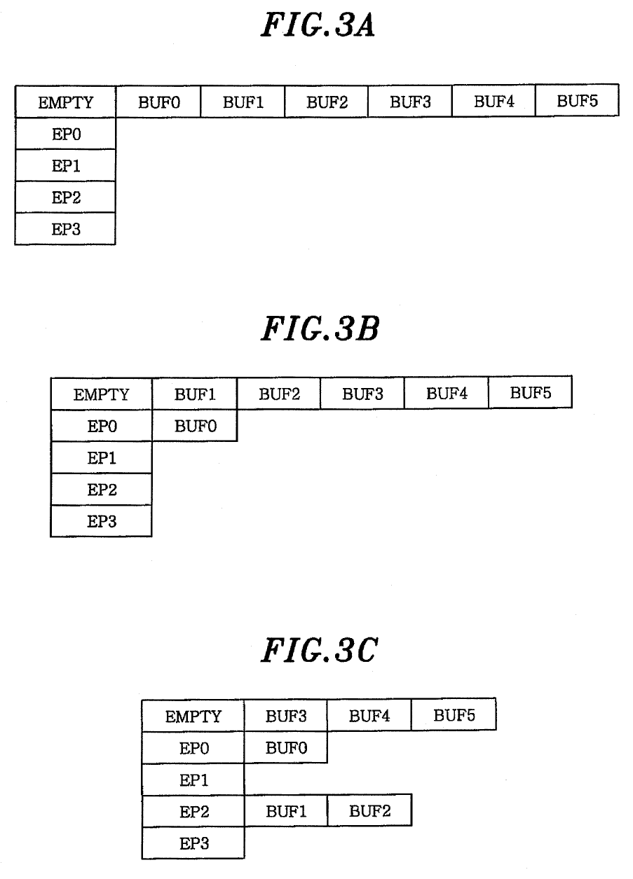

Example FIG. 2 is a block diagram showing a configuration of the USB device in accordance with embodiments.

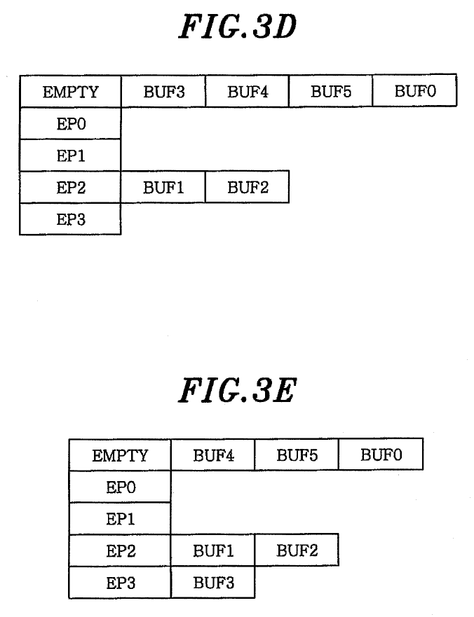

Example FIGS. 3A to 3G show a process of assigning and returning an end point memory within a USB device according to embodiments.

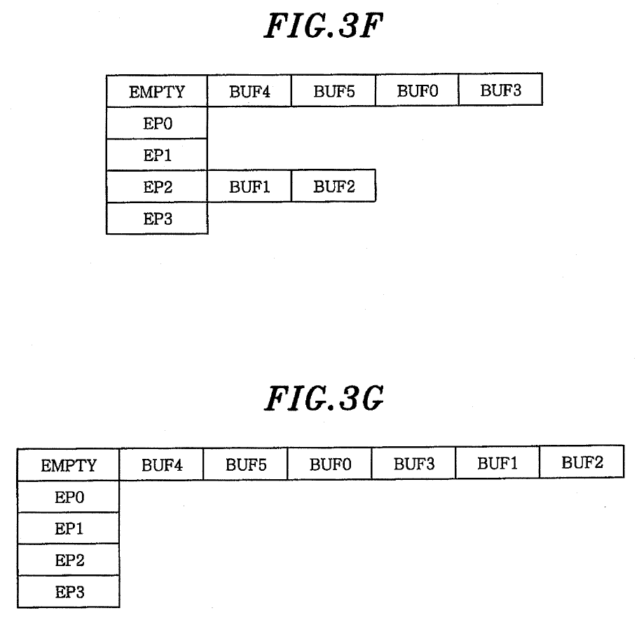

Example FIG. 4 shows a general connection list material structure.

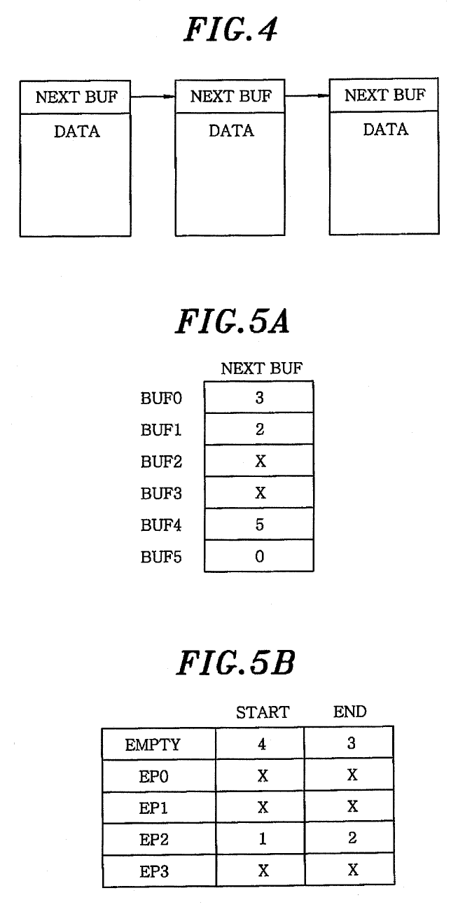

Example FIG. 5A shows pointers of buffer segments stored in an address map in the state shown in example FIG. 3F.

Example FIG. 5B shows designation of start points and end points of buffer segments of an EMPTY state or EP0 to EP3 assignment states in the address map in the state shown in example FIG. 3F.

### DESCRIPTION

In embodiments, an end point memory, i.e., a buffer, is beforehand divided into segments an equal size. No segment is initially assigned to an end point.

When a USB device transmits data to a host, MCU of the USB device stores data to be transmitted in a transmission end point memory. When an In token, which is a transmission request signal sent from the host, is detected, the MCU transmits the stored data sequentially. In case of control, interrupt and bulk transmission, transmission is completed when the USB device receives an ACK signal from the host. In the case of isochronous transmission, transmission is completed when the USB device has transmitted data to the host. In this case, since buffer segments need not to be used any longer once the transmission has been completed, a buffer segment assigned to a transmission-completed portion is returned.

The USB device may receive data from the host through a reception end point memory. The host sends an OUT token, which is a reception request signal, and buffer segments, which have not been assigned at that time, are assigned as much as needed. Reception is completed when an error check confirms no errors in the received data. In this case, since buffer segments need not to be used any longer once the reception has been completed, a buffer segment assigned to a corresponding portion is returned.

The entire buffer segments assigned and returned in the device need not to have the same size. The buffer segments may have different sizes depending on whether an end point is a transmission end point or a reception end point. The entire buffer segments may be shared between only some end points, or only some points may operate some buffer segments.

Example FIG. 2 is a block diagram showing a configuration of the USB device in accordance with embodiments. The USB device includes a controller 10 and an end point memory 20. The controller 10 includes assignment module 12 for assigning the memory to an end point at the point of time when the memory starts to be actually used and returning module 14 for returning the memory, which was assigned to the end point, at the point of time when the actual use of the memory is ended.

Example FIGS. 3A to 3G show a process of assigning and returning an end point memory within a USB device according to embodiments.

In embodiments, since the number of buffer segments assigned to each end point for one transmission may be changed and buffer segments are designated at the point of time when a request for an end point is actually generated, data are not transmitted in an order designated for buffer segments by MCU. EMPTY in example FIGS. 3A to 3G means no assignment.

Referring to example FIG. 3A, it may be assumed in embodiments that the entire end point memories are divided into 6 equal segments and 4 end points are present. Here, it may also be assumed that EP0 and EP1 are set as reception end points and EP2 and EP3 are set as transmission end points.

As shown in example FIG. 3B, when a host issues an OUT token in order to send data to the USB device, a request for a reception end point memory of the USB device is generated. Since the reception end point EP0 needs one buffer segment for reception, a buffer segment BUF0 having the EMPTY state is assigned to EP0.

Referring to example FIG. 3C, the reception data are stored in BUF0. If the MCU of the USB device attempts to transmit data to the host at a point of time when the reception of data from the host has not yet been completed, a request for the transmission end point EP2 is generated. Depending on a characteristic of transmission data, EP2 may need a space corresponding to two buffer segments. In this case, buffer segments BUF1 and BUF2, previously in the EMPTY state, are assigned to EP2 and data to be transmitted by the MCU of the device are stored in BUF1 and BUF2.

Referring to example FIG. 3D, if the reception end point EP0 has completed the reception and there is no error in the received data, the data are passed to the MCU. In this case, the buffer segment BUF0 assigned to EP0 is not needed any longer and thus is returned.

Referring to example FIG. 3E, if the MCU intends to transmit other data to the host under a situation where the transmission end point EP2 has not yet received an IN token from the host, a request for another transmission end point EP3 is generated. If the number of buffer segments required depending on a characteristic of the transmission data is 1, a buffer segment BUF3 of the EMPTY state is assigned to EP3 and data to be transmitted by the MCU of the device are stored in BUF3.

Referring to example FIG. 3F, when the transmission end point EP3 receives an IN token from the host, the transmission is processed. If EP3 is designated to perform isochronous transmission, the request for the transmission end point EP3 is extinguished at the point of time when data are transmitted. On the other hand, if EP3 is designated to perform control, interrupt or bulk transmission, the request for the transmission end point EP3 is extinguished at the point of time when an ACK signal is received from the host. Accordingly, the buffer segment BUF3 assigned to EP3 becomes meaningless and thus is returned.

Referring to example FIG. 3G, if EP2 receives an IN token from the host later, when the transmission is processed as described above, the request for the transmission end point EP2 is extinguished. Accordingly, the buffer segments BUF1 and BUF2 assigned to EP2 are not needed any longer and thus may be returned.

In order to determine whether each buffer segment is not assigned, i.e., is in the EMPTY state, or is assigned to one of EP0 to EP3, an address map is needed, either in the buffer segment itself or separately from the buffer segment. The address map may store information on whether or not each buffer segment is assigned to an end point, and information about the order in which each buffer segment is assigned. The address map may be represented as shown in example FIGS. 3A to 3G.

Implementation of the address map requires a storage space for designating buffer segments in the EMPTY state or designating buffer segments to be assigned to particular one(s) of EP0 to EP3. Each storage space may store two kinds of information, i.e., a pointer indicating a start point of a corresponding buffer segment and a pointer indicating an end point of the corresponding buffer segment. The pointers stored in the storage space may indicate addresses of buffer segments. However, since pointers of buffer segments having an equal size can be easily calculated, the pointers may indicate index values for saving the storage space.

Example FIG. 4 shows a general connection list material structure used in embodiments. As shown in example FIG. 4, a pointer indicating Next BUF at each node is tied with data. However, this shows only a logical concept and pointers may be stored in a separate memory.

Referring again to example FIG. 3F showing the address map to which a connection list is applied, BUF4 is stored as a start point in an EMPTY storage space, BUF5 is stored in a Next BUF storage space of a buffer segment corresponding to BUF4, BUF0 is stored in a Next BUF storage space of a buffer segment corresponding to BUF5, and BUF3 is stored as an end point in a Next BUF storage space of a buffer segment corresponding to BUF0. On the other hand, BUF1 is stored as a start point in an EP2 storage space, and BUF2 is stored in a Next BUF storage space of a buffer segment corresponding to BUF1.

Example FIG. 5A shows pointers of buffer segments stored in an address map in the state shown in example FIG. 3F when a connection list is used.

Example FIG. 5B shows designation of start points and end points of buffer segments of an EMPTY state or EP0 to EP3 assignment states in the address map in the state shown in example FIG. 3F when a connection list is used.

Referring to example FIG. 5A, an index value of 4 corresponding to BUF4 is stored as a start point in the EMPTY storage space. Referring to example FIG. 5B, an index value of 5 is stored in the Next BUF storage space of a buffer segment corresponding to BUF4, an index value of 0 is stored in the Next BUF storage space of a buffer segment corresponding to the index value of 5, and an index value of 3 is stored as an end point in the Next BUF storage space of a buffer segment corresponding to the index value of 0. This can be confirmed from storage of the index value of 3 in an end point of EMPTY in example FIG. 5B. On the other hand, referring to example FIG. 5A, an index value of 1 corresponding to BUF1 is stored as a start point in the EP2 storage space. Referring to example FIG. 5B, an index value of 2 is stored in the Next BUF storage space of a buffer segment corresponding to the index value of 1. This can be confirmed from storage of the index value of 2 in an end point of EP2 in example FIG. 5B.

The above-described method including the assigning step and the returning step may automatically performed by a controller, e.g., an MCU, within the USB device. In general, when the USB device receives data from the host, the host performs various controls including scheduling used for memory management in a data communication process. On the other hand, when the USB device transmits data to the host, the MCU of the USB device performs various controls. According to embodiments, assignment and return of end point memories can be achieved in both of transmission and reception by the MCU of the USB device.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. A method comprising:
assigning empty memory in a USB device, the USB device capable of conducting data communication with an external host, to an end point buffer memory in the USB device at the point of time when the end point buffer memory starts to be actually used for at least one of data transmission and data reception; and
returning the memory, which was assigned to the end point buffer memory, at the point of time when the actual use of the memory is ended, to an empty state.

2. The method of claim 1, wherein the end point buffer memory is a reception end point buffer memory.

3. The method of claim 2, wherein the point of time when the actual use starts is a point of time when the USB device receives an OUT token from the host.

4. The method of claim 1, wherein the point of time when the actual use is ended is a point of time when the USB device confirms that data received from the host have no errors.

5. The method of claim 1, wherein the end point buffer memory is a transmission end point buffer memory.

6. The method of claim 5, wherein transmission of the data communication is one of control, interrupt and bulk transmission, and the point of time when the actual use is ended is a point of time when the USB device receives an ACK signal from the host.

7. The method of claim 5, wherein transmission of the data communication is isochronous transmission, and the point of time when the actual use is ended is a point of time when the USB device transmits data to the host.

8. The method of claim 1, wherein memory is divided into segments having an equal size and an address map stores one of addresses and pointers of index values.

9. The method of claim 8, including dividing the memory into segments assigned to the end point buffer memory and segments not assigned to the end point buffer memory.

10. The method of claim 9, wherein the address map uses a connection list material structure.

11. An apparatus adapted to:
assign empty memory in a USB device, the USB device capable of conducting data communication with an external host, to an end point buffer memory in the USB device at the point of time when the end point buffer memory starts to be actually used for at least one of data transmission and data reception; and
return the memory, which was assigned to the end point buffer memory, at the point of time when the actual use of the memory is ended, to an empty state.

12. The apparatus of claim 11, wherein the end point buffer memory is a reception end point buffer memory.

13. The apparatus of claim 12, wherein the point of time when the actual use starts is a point of time when the USB device receives an OUT token from the host.

14. The apparatus of claim 11, wherein the point of time when the actual use is ended is a point of time when the USB device confirms that data received from the host have no error.

15. The apparatus of claim 11, wherein the end point buffer memory is a transmission end point buffer memory.

16. The apparatus of claim 15, wherein transmission of the data communication is one of control, interrupt and bulk transmission, and the point of time when the actual use is ended is a point of time when the USB device receives an ACK signal from the host.

17. The apparatus of claim 15, wherein transmission of the data communication is isochronous transmission, and the end point is a point of time when the USB device transmits data to the host.

18. The apparatus of claim 11, wherein the memory is divided into segments having an equal size and an address map stores one of addresses and pointers of index values.

19. The apparatus of claim 18, adapted to divide the memory into segments assigned to the end point buffer memory and segments not assigned to the end point buffer memory.

20. The apparatus of claim 19, wherein the address map uses a connection list material structure.
